(19) United States
(12) Patent Application Publication
(10) Pub. No.: US 2003/0186052 A1
(43) Pub. Date: Oct. 2, 2003

(54) Fiber pellets and processes for forming fiber pellets

(75) Inventors: Jerry W. Crews, Los Alamitos, CA (US); Darren Traub, Irvine, CA (US); Murray Wishengrad, Newport Beach, CA (US)

Correspondence Address: ORRICK, HERRINGTON & SUTCLIFFE, LLP, 4 PARK PLAZA, SUITE 1600, IRVINE, CA, 92614-2558, US

(73) Assignee: CYTECH FIBER PROCESSING SYSTEMS, INC.

(21) Appl. No.: 10/109,816

(22) Filed: Mar. 29, 2002

(51) Int. Cl. D02G 3/00

(52) U.S. Cl. 428/375

(57) ABSTRACT

Low moisture processed cellulose fiber pellets useful in the manufacture of cellulose fiber reinforced polymer products and materials, and an extruder-less process for forming such low moisture cellulose fiber pellets from wet processed cellulose fiber-based waste source materials. The cellulose fiber pellets include processed cellulose fibers and mixed plastics and/or inorganics such as minerals, clay, and the like, and have a moisture content of about 0.1 to 14% by weight. The extruder-less process includes the steps of drying, grinding and pelletizing in a manner capable of forming low moisture cellulose fiber pellets from wet processed cellulose fiber-based waste source materials having a moisture content of about 40-80% by weight.

### FIELD OF THE INVENTION

The present invention relates generally to cellulose fiber pellets and, more particularly, to non-extruded cellulose fiber pellets having low moisture content and a process that facilitates forming cellulose fiber pellets from wet waste source materials.

### BACKGROUND OF THE INVENTION

Polymers reinforced with a variety of fillers are widely used in the manufacture of household and industrial products, as well as building materials and the like. By compounding in mineral fillers such as calcium carbonate, talc, mica and wollastonite and synthetic fillers such as glass, graphite, carbon and Kevlar fibers, as well as natural fibers, such as cellulose fiber, some of the mechanical properties of these polymers are vastly improved. The cellulose fiber used to reinforce polymers typically includes wood flour or ground wood fiber having an effective mesh size of about 10 to 60 mesh. Use of such cellulose fiber fillers tends to have many drawbacks as a result.

For instance, because of low bulk density and the need for pre-drying before or during compounding, processing with wood flour or ground wood fiber results in low production rates and high costs. The powdery consistency of such fillers not only results in a messy operation, but tends to pose potential health risks to those manning the processing. Wood flour and ground wood fiber also tend to cause blocking or agglomeration due to the material packing together and tend to be extremely difficult to convey and feed into an extruder, the inlet of which is typically small relative to the low bulk density of these materials.

To avoid the problems associated with using the powdery wood flour or ground wood fiber, compressing the fiber into pellets has been attempted. Conventional methods of using a pellet mill and forming pellets out of ground wood fiber or wood flour involve using water as a binder. However, the resulting moisture in these pellets becomes a liability for downstream processing of the composite pellets. Where polymers are used as a binder, the polymer must be added to the process, thus raising processing costs.

In addition to these problems, the use of ground wood fiber or wood flour as the raw material for forming cellulose fiber-polymer pellets or directly forming cellulose fiber enhanced polymer materials or products, tends to be quite costly. Other sources of more cost-effective cellulose fiber based raw materials have tended to be over looked due to the industry's focus on ground wood fiber or wood flour as the preferred raw material. For example, materials found in the waste streams of most paper mills could provide an abundant supply of processed cellulose fiber. Today, paper mills discard millions of tons per year of processed cellulose fiber along with other materials such as plastics and/or inorganics that are not suitable for use in the paper mill process. To date, no process exists to handle this substantially wet waste cellulose material and place it in a pellet form useful for manufacturing composites, as well as for fuel, animal bedding, landscaping, and a host of other processed fiber uses.

Thus, it is desirable to provide a processed cellulose fiber pellet having low moisture content and high bulk density, and a process by which such cellulose fiber pellets can be manufactured using a wet waste processed cellulose fiber based source material.

### SUMMARY OF THE INVENTION

The present invention is directed to improved, low moisture cellulose fiber pellets useful in the manufacture of cellulose fiber reinforced polymer products and materials as well as fuel, animal bedding, landscaping, and a host of other processed fiber uses, and to an improved extruder-less process for converting wet processed cellulose fiber-based waste source materials into such low moisture cellulose fiber pellets. In one innovative aspect, the cellulose fiber pellets of the present invention have a moisture content of about 0.1 to 14% by weight, and most preferably about 1.0 to 5% by weight. In another innovative aspect, the extruder-less process of the present invention produces low moisture cellulose fiber pellets from wet processed cellulose fiber-based waste source materials having a moisture content of about 40 to 80%, by weight. In yet another innovative aspect, materials used in the extruder-less process of the present invention to assist in binding the cellulose fibers in pellet form, such as plastics and/or inorganics such as minerals, clay, and the like, are indigenous to the source material. In contrast to the prior art, there is no need to add such ingredients as binders.

In a preferred embodiment, the cellulose fiber pellets of the present invention comprise free-flowing cylindrical or spherical fiber pellets having a moisture content of about 0.1 to 14.0% by weight and, preferably, about 1.0 to 5.0% by weight. The cellulose fiber pellets preferably comprise processed cellulose fiber in a range of about 60 to 99% by weight, plastics in a range of about 0 to 30% by weight, and/or inorganics or ash including minerals, clay and the like, in a range of about 0 to 40% by weight, wherein the pellets preferably include at least about 1 to 5% by weight of either plastics or inorganics and not more than about 40% by weight of combined plastics and inorganics. The length and/or diameter dimensions of the pellets are in a range of about 1/16 inches to 2 inches and, preferably, ⅛ inches to ½ inches. The bulk density of the pellets is preferably in a range of about 12 to 50 lb./cu.ft., and preferably in the range of about 20 to 40 lb./cu.ft.

Preferably, the fiber pellets are produced from wet processed cellulose fiber-based raw material. The processed cellulose fiber based raw material is preferably sourced from paper sludge and other reject streams from one or more stages of production at paper mills. This waste stream material typically comprises a mixture consisting primarily of processed cellulose fiber and mixed plastics and/or inorganics such as minerals, clay, and the like. The mixed plastics typically include one or more polyolefins, such as but not limited to polyethylene, polypropylene, polybutene, and polystyrene. The moisture content of this waste stream material tends to be about 40 to 80% by weight and the weight by weight ratios of cellulose to plastics and/or inorganics tend to be in a range of about 99 to 1% to 60 to 40%.

In another preferred embodiment, the extruder-less process of the present invention comprises receiving and drying a wet processed cellulose fiber based source material, grinding the dried material, and then pelletizing the dried, ground material. Optionally an additional drying step between the grinding and pelletizing could be used to enhance the efficiency of the drying. Preferably, commercially available drying systems and processes may be used to dry the source material of cellulose and mixed plastics and/or inorganics having a moisture content in the range of about 40 to 80% by weight to a moisture content of about 0.1 to 14.0% by weight and, most preferably, to about 1.0 to 5.0% by weight. The grinding step may be accomplished using commercially available shredders or granulators, ball mills and/or hammer mills to grind the material comprised of cellulose and mixed plastics and/or inorganics down to a particle size in an effective mesh range of about 10 to 60 mesh. Depending upon the source of the fiber and the extent and type of the grinding carried out, the aspect ratio of the cellulose fiber can be in the range of 10:1 to 300 to 1. Lastly, the pelletizing step, which may comprise compaction, pelletization and/or densification may be accomplished using commercially available screw presses, pellet mills, and/or compacting presses to compact the dried and ground source material and form pellets. Preferably the source material is compacted from a bulk density of about 1 to 10 pounds per cubic foot to a bulk density in a range of about 12 to 50 pounds per cubic foot and, preferably, in a range of about 20 to 40 pounds per cubic foot, and then forming pellets having length and/or diameter dimensions in a range of about 1/16 inches to 2 inches and, preferably, in a range of about ⅛ inches to ½ inches.

The fiber pellets prepared by the process of the present invention advantageously have several applications, in addition to the manufacture of composites, for which they may be used. For example, the fiber pellets may be used as animal bedding, landscaping material, fuel for power generation, and the like. When used as animal bedding or in landscaping, the higher bulk density aids in preventing the cellulose fiber from being blown away by wind and gusts, while allowing the fiber to absorb and then provide nutrients for feeding plants and trees in the case of landscaping and deodorants in the case of animal bedding. The lower moisture levels attained by the process of the present invention also allow for higher absorption of nutrients and deodorants not previously attained by fiber pellets produced by conventional pellet mill processes alone.

Similarly the lower moisture and higher bulk density attained by the process of the present invention more than doubles the thermal energy generated in terms of B.T.U. from each pound or ton of raw material received, which more than justifies processing costs for preparing such fiber pellets in accordance with the present invention.

Further, objects and advantages of the invention will become apparent from the following detailed description and accompanying drawings.

### BRIEF DESCRIPTION OF DRAWINGS

FIG. 1A is a perspective view schematic illustration of a processed cellulose fiber-based pellet of the present invention.

FIG. 1B is a photograph of processed cellulose fiber-based pellets of the present invention.

FIG. 2 is a flow diagram of a process in accordance with the present invention for forming a cellulose fiber-based pellet from a wet waste source of cellulose fiber-based materials.

FIG. 3 is a schematic process diagram detailing an exemplary system for carrying out the process of the present invention.

### DETAILED DESCRIPTION OF PREFERRED EMBODIMENTS

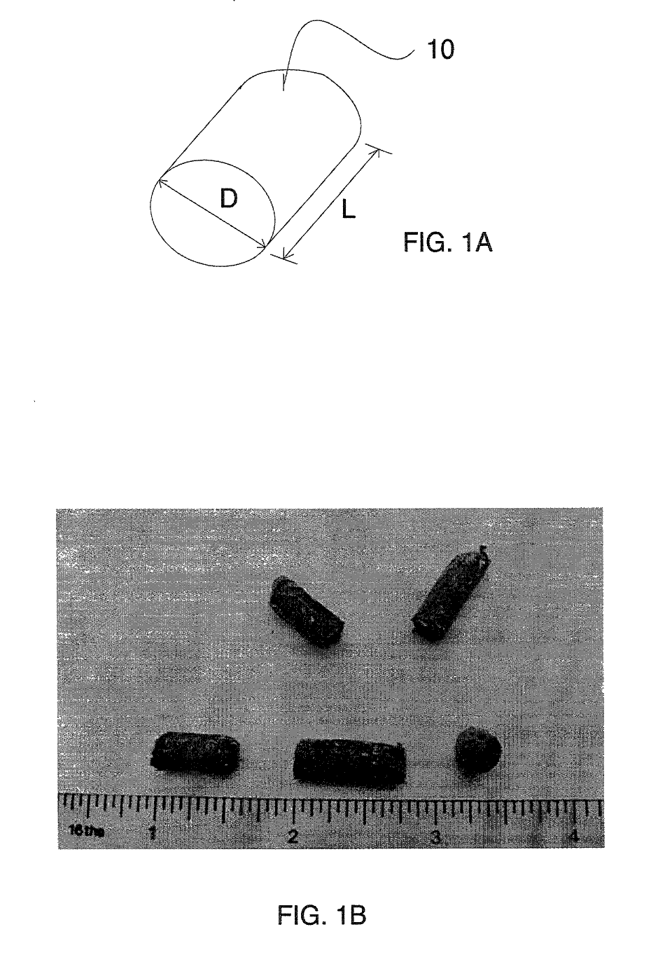

The present invention is directed to improved, low moisture cellulose fiber pellets useful in the manufacture of cellulose fiber reinforced polymer products and materials as well as for fuel, animal bedding, landscape material and for a host of other processed fiber uses, and to an improved extruder-less process for converting wet processed cellulose-based waste source materials into such low moisture cellulose fiber pellets. Turning to FIG. 1A, a cellulose fiber pellet 10 in accordance with the present invention, which may be cylindrical or spherical in shape, is shown schematically to be generally cylindrical in shape and having diameter D and length L dimensions in a range of about 1/16 inches to 2 inches and, preferably, ⅛ inches to ½ inches. A photograph of typical fiber pellets of the present invention is provided in FIG. 1B.

Preferably, the moisture content of the cellulose fiber pellets of the present invention is in a range of about 0.5 to 14.0% by weight and, preferably, about 1.0 to 5.0% by weight and the bulk density of the pellets is in a range of about 12 to 50 lb./cu.ft., and preferably in the range of about 20 to 40 lb./c. ft. The cellulose fiber pellets preferably comprise, by weight, cellulose fiber in a range of about 60 to 99%, plastics in a range of about 0 to 30%, and/or inorganics or ash, such as minerals, clay, and the like, in a range of about 0 to 40%, wherein the pellets preferably include at least about 1 to 5% of either plastics or inorganics and not more than about 40% of combined plastics and inorganics.

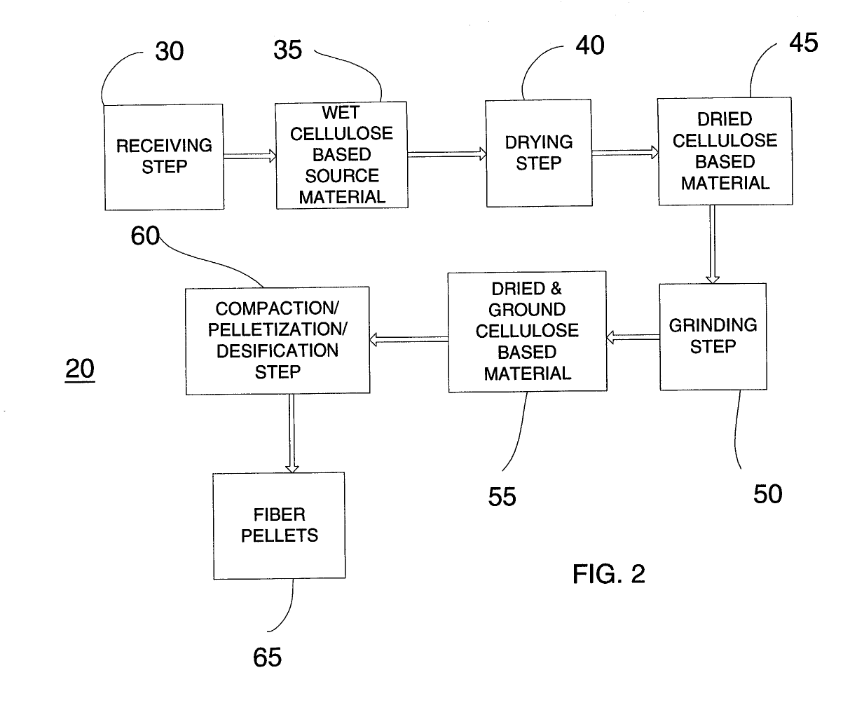

As FIG. 2 depicts, the cellulose fiber pellets 65 of the present invention are produced from a wet processed cellulose fiber-based raw material 35. This raw material 35 is preferably sourced from paper sludge and other reject streams, including primary and secondary reject streams, from one or more stages of production at paper mills. The reject streams include material that is rejected at each stage as unsuitable for use in the paper making process and typically finds it way to a landfill. The waste material generally comprises a mixture consisting primarily of processed cellulose fiber and mixed plastics, including one or more polyolefins, such as but not limited to polyethylene, polypropylene, polybutene, and polystyrene, and/or inorganics such as minerals, clay, and the like. However, the amount of paper sludge, waste fiber, plastics and inorganics in such reject streams varies tremendously depending upon the type of product produced at the paper mill. This can vary in terms of the proportion of cellulose fiber to inorganics and to mixed plastics. For example in a coated paper mill, which glossy paper for magazines is produced, mineral content could be as high as 40% by weight (based on total solids) with virtually no plastics at all. On the other hand, an old corrugated cardboard (OCC) recycled paper mill, which uses several steps to recover long cellulose fiber to include in the paper making process, could have waste material with inorganic content from 0 to 15% by weight and plastics content from 2% to 30% by weight, depending upon the efficiency of the fiber recovery process at that paper mill. There are, however, lots of variants in between these examples for other paper mills for office paper, bleached board for milk cartons, bleached board for ovenable TV dinners, non-recycled Kraft paper for corrugated or brown bags, tissue paper and the myriad of paper products. Thus, the weight by weight ratios of cellulose to plastics and/or inorganics tend to be in a range of about 99 to 1% to 60 to 40%, while the moisture content tends to be in a range of about 40 to 80% by weight for such waste material.

As shown in the illustrated embodiment in FIG. 2, the extruder-less pellet fabrication process 20 of the present invention comprises a receiving step 30 for receiving and introducing the wet cellulose based raw material 35 into the process 20. The receiving step is followed by a drying step 40 to dry cellulose-based raw material 35. After the drying step 40, a grinding step 50 is used to reduce the size of the dried cellulose based material 45. The grinding step 50 is then followed by a compaction, pelletization and/or densification step 60 used to compact the dried, ground material 55 and form fiber pellets 65. Optionally an additional drying step between the grinding 50 and pelletizing 60 steps could be used to enhance the efficiency of the drying.

The drying step 40 of the present invention may be accomplished with a variety of drying processes and commercially available drying systems known to one skilled in the art such as rotary, centrifuge, kiln, fluidized bed, flash, or cyclonic dryers, and/or screw presses. Preferably, the drying step 40 of the present invention is accomplished using a drying system described in U.S. Pat. No. 5,915,814 or U.S. Pat. No. 5,7891,066, the disclosures of which are incorporated by reference. The drying step 40 is used to dry the raw material 35 to a moisture content of about 0.1 to 14.0% by weight and, most preferably, to about 1.0 to 5.0% by weight. The starting moisture content of the raw material 35 is typically in a range of about 40 to 80% by weight when is introduced into the process 20. If screw presses are used, the moisture content would typically be reduced to about 40% prior to entering the drying system.

Like the drying step 40, the grinding step 50 may be accomplished with a variety of grinding processes and commercially available grinding systems known to one skilled in the art such as commercially available shredders or granulators, ball mills and/or hammer mills. Depending on the specific application, the grinding step 50 would be used to grind the dried cellulose and mixed plastics and/or inorganics material 45 down to a particle size in an effective mesh range of about 10 to 60 mesh. Depending upon the source of the fiber and the extent and type of the grinding carried out, the aspect ratio of the cellulose fiber can be in the range of 10:1 to 300 to 1.

The compaction, pelletization and/or densification step 60, like the drying and grinding steps 40 and 50, may be accomplished with a variety of densifying and pelleting processes and commercially available screw presses, pellet mills, and/or compacting presses know to one of skill in the art. The purpose of this step 60 is to densify, preferably with a pellet mill, the dried and ground material 55 from a bulk density of about 1 to 10 pounds per cubic foot to a bulk density in a range of about 12 to 50 pounds per cubic foot and, preferably, in a range of about 20 to 40 pounds per cubic foot. The densified material is then pressed through a die at temperatures as high as about 300° F. (177° C.), and preferably about 250° F. (121° C.), and cut into fiber pellets 65 having a generally cylindrical geometry with length and diameter dimensions in a range of about 1/16 inches to 2 inches and, preferably, in a range of about ⅛ inches to ½ inches. The plastic and/or inorganic content tends to melt below this temperature to bind the cellulose fibers and provide integrity to the fiber pellets.

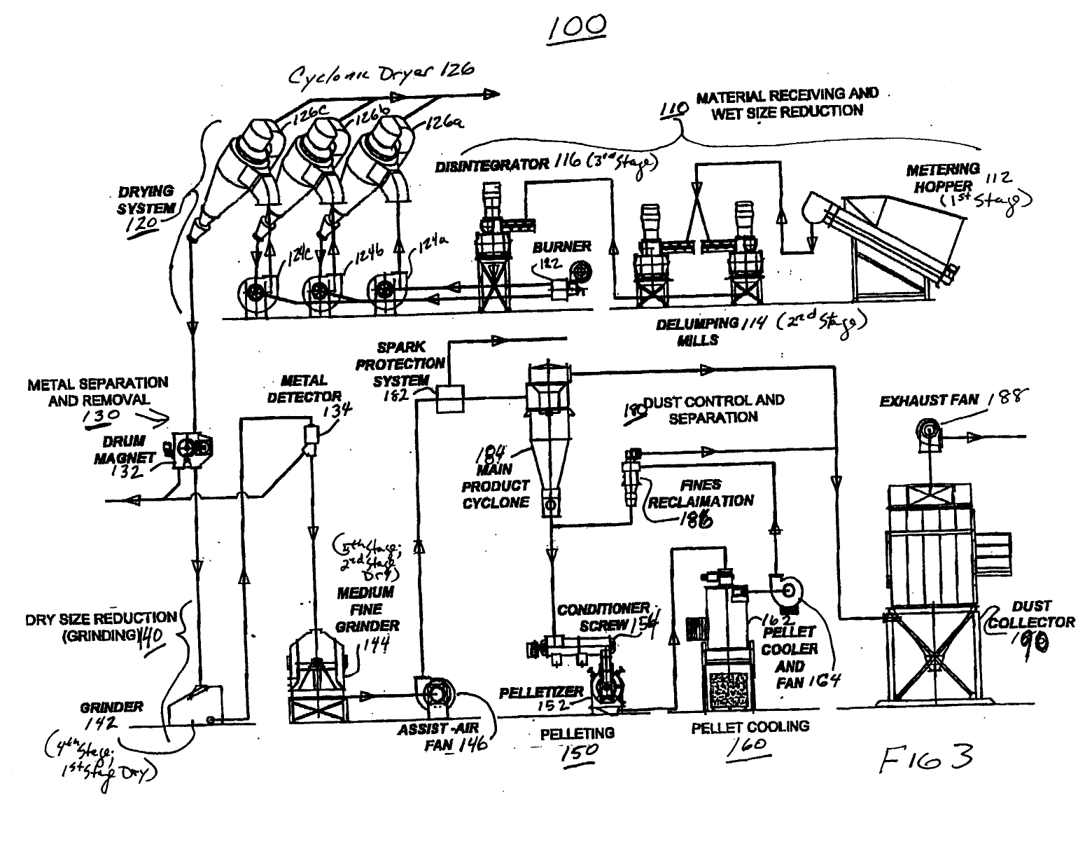

Referring to FIG. 3, a scalable, extruder-less pellet fabrication system 100 capable of carrying out the process of the present invention is shown and described herein for exemplary purposes only. As depicted, the illustrated embodiment includes the following interconnected subsystems: a material receiving and wet size reduction subsystem 110; a drying subsystem 120; a metal separation and removal subsystem 130; a dry size reduction subsystem 140; pelleting and pellet cooling subsystems 150 and 160; and a dust control and separation subsystem 180.

In operation, raw material of wet cellulose and mixed plastics and/or inorganics is received and introduced into the system 100 through the material receiving and wet size reduction subsystem 110. The insertion point is a metering hopper 112, which controls the rate at which raw material is introduced into the system 100 and provides a first stage of size reduction in the wet raw material. De-lumping mills 114, which tend to release the plastics and/or inorganics from paper clumps, receives material from the metering hopper 112 and provide a second stage of size reduction in the wet raw material. A disintegrator 116, which opens paper further for more efficient drying, receives material from the de-lumping mills and provides a third and final wet stage size reduction in the wet raw material. At this stage, the material is preferably reduced by the disintegrator 116 preferably to flakes having a major dimension preferably on the order of about 0.75″ to 1.00″ inches in order to avoid increasing the dust formation in the drying process. The actual size of the material tends to depend on the grinders used and the final material size desired for pelletizing, and on the needs of the specific application for each customer.

The wet raw material is conveyed from the disintegrator 116 to the drying subsystem 120, which includes a dryer system 126 and a hot air source, i.e., burner 122, and fans 124 to convey the wet raw material into the dryer system 126 in a hot air stream. The dryer system 126 preferably includes a series of patented cyclonic dryers 126a, 126b, and 126c (see e.g., U.S. Pat. No. 5,915,814 or U.S. Pat. No. 5,7891,066).

Once dried, the raw material is conveyed through a drum magnet 132 that is part of metal separation and removal subsystem 130 for removal of primary metals, including all ferrous materials—staples, wires, bolts, etc. The material continues on to the dry size reduction, i.e., grinding, subsystem 140. The grinding subsystem 140 includes a first dry stage grinder 142, which corresponds to a fourth stage size reduction overall. The primary function of the first grinder 142 is to reduce the size of the plastics and/or inorganics in the stream of dry raw material preferably to flakes having a major dimension preferably on the order of about 0.25″ to 0.75″ depending on the final sized desired for pelletizing. The raw material is conveyed to a second or medium/fine grinder 144 after passing through a metal detector 134. The metal detector 134 provides a final metals removal stage that rejects all ferrous and non-ferrous materials, aluminum, stainless steel, copper, etc. The primary function of the second grinder 144, which provides a second stage of dry size reduction and final stage size reduction overall, is to grind dry material to a final size for pelleting, preferably in an effective mesh size range of about 10-60 mesh. Depending upon the source of the fiber and the extent and type of the grinding carried out, the aspect ratio of the cellulose fiber can be in the range of 10:1 to 300 to 1. An assist air fan 146 provides air to assist in the final size reduction and the transport of material to the next phase of the system 100.

The material next enters a main product cyclone 184, which is part of the dust control and separation subsystem 180, where material is separated from the air stream. Air and dust exit from top of the cyclone 184 and are directed to the dust collector 190. The dried ground material exits the bottom of the cyclone 184 where it enters a conditioner screw 154 of the pelleting subsystem 150.

The conditioner screw 154 pre-conditions the material for pelleting by providing for the optional use of minor amounts of additives, such as binders, and thermal stabilizers and de-aerating, i.e., removing air from the material. From the conditioner screw 154, the material enters the pelletizer 152, which converts fluffy material of low bulk density into dense pellets providing a higher bulk density. The formed pellets, which are hot, enter the pellet cooling subsystem 160 comprising a pellet cooler 162 and fan 164. The pellet cooler 162 cools the pellets prior to packaging while the fan 164 assists in cooling the pellets and transporting fine particles to a fines particle reclamation device 186. The reclamation device 186 collects fine particles from the air stream for re-introduction into the conditioner screw 154 for pelleting.

A spark protection system 182 is interposed along the material stream between the grinding subsystem 140 and the main product cyclone 184. On level one, the spark protection system 182 will divert material flow and remove and quench spark from the system. On level two, the spark protection system 182 will extinguish any fire or potential explosion from the system ductwork and bag house, i.e., the dust collector 190.

The fiber pellets prepared by the process of the present invention advantageously have several applications in addition to the manufacture of composites. For example, the fiber pellets may be used as animal bedding, landscaping material, fuel for power generation, and the like. When used as animal bedding or in landscaping, the higher bulk density tends to aid in preventing the cellulose fiber from being blown away by wind and gusts, while allowing the fiber to absorb and then provide nutrients for feeding plants and trees in the case of landscaping and deodorants in the case of animal bedding. The lower moisture levels attained by the process of the present invention also allows for higher absorption of nutrients and deodorants not previously attained by fiber pellets produced by conventional pellet mill processes alone.

Similarly the lower moisture and higher bulk density attained by the process of this invention more than doubles the thermal energy generated in terms of B.T.U. from each pound or ton of raw material, which more than justifies processing costs for preparing such fiber pellets in accordance with the present invention.

Experiments

Experiment No. 1: 4000 pounds of raw material comprising cellulose and mixed plastics having a composition by weight of about 90% cellulose and 10% inorganics and 0% plastics and a moisture level of about 70% by weight was collected from a cellulose fiber reject stream from a paper mill that produces tissue paper. The wet raw material was dried using a cyclonic dryer to a moisture level of about 7% and ground to a 30 mesh powder. The powder was then converted to fiber pellets using a pellet mill.

Experiment No. 2: 35,000 pounds of raw material was collected from a paper mill's secondary screen reject stream that produces corrugated medium comprising by weight about 90% cellulose and 10% plastics and having a moisture level of about 60%. The material was dried using a large cyclonic dryer and ground to flakes, preferably approximately 0.25″ to 0.75″ in size, using a conventional grinder. This dried material was then ground further, preferably to an effective mesh size range of about 10-60 mesh on a conventional swinging hammer mill. The dried ground material was then pelletized using a conventional pellet mill into cylindrical fiber pellets that ranged in length from 0.75″ to 2″ and a diameter of about 0.35″. The formed pellets had a bulk density of about 35 lb./c.ft. The pellets had moisture content of about 4% by weight, a cellulose fiber content of about 77% by weight, a mixed plastics content of about 19% by weight, and an ash content below about 0.1% by weight.

Experiment No. 3: 40,000 lb. pounds of raw material was collected from a paper mill's primary and secondary screen reject streams that produce corrugated medium comprising by weight 80% cellulose and 20% plastics and having a moisture level of 65%. The material was processed as described in Experiment No. 2. Fiber pellets were produced having a moisture content of about 5.6%, a mixed plastics content of about 18% and a cellulose fiber content of about 76.2%, with zero ash content. The fiber pellets had a diameter of about 0.38″ to 1.85″. The aspect ratio of the fibers was found to range between 40:1 and 100:1.

Experiment No. 4: From a bleached board paper mill that produces SBS paper sheet, 8 drums of primary sludge were dried from a moisture level of about 50% using a cyclonic dryer to a moisture level of 5%. The dried sludge was then ground on a hammer mill to below 40 mesh powder and then pelletized using a pellet mill. The formed pellets contain by weight about 70% cellulose fiber, about 23% primarily clay, about 3% moisture, and about 4% mixed plastics. The particle size of the fiber was found to be in the range of 30 microns to 1000 microns with an aspect ratio in the range of 10:1 to 30:1. The fiber pellet had a high bulk density of about 40 lb./cu.ft.

Experiment No. 5: 30,000 pounds of secondary screen rejects from a paper mill that produces unbleached paper was processed as described in Experiment No. 2. The reject material, with moisture content of 55%, was reduced to fiber pellets produced with the following composition: about 85% cellulose fiber, about 3% about 4% moisture and about 8% mixed plastics. The fiber pellets had a diameter of about 0.34″ and a length that ranged from 0.5″ to 1.75″.

Experiment No. 6: 18,000 pounds of secondary screen rejects from a paper mill that produces unbleached paper was processed as described in Experiment No. 2. The reject material, with moisture content of 56%, was reduced to fiber pellets produced with the following composition: about 82% cellulose fiber, about 8% about 2% moisture and about 8% mixed plastics. The fiber pellets had a diameter of about 0.33″ and fiber length that ranged from 0.15″ to 0.55″.

While various preferred embodiments of the invention have been shown for purposes of illustration, it will be understood that those skilled in the art may make modifications thereof without departing from the true scope of the invention as set forth in the appended claims including equivalents thereof.

What is claimed:

1. A fiber pellet formed in an extruder-less process, comprising processed cellulose fibers and having moisture content in a range of about 0.1 to 14.0 percent by weight.

2. The fiber pellet of claim 1 wherein the moisture content is in a range of about 1.0 to 5.0 percent by weight.

3. The fiber pellet of claim 1 further comprising plastic material.

4. The fiber pellet of claim 1 further comprising inorganic material.

5. The fiber pellet of claim 1 further comprising ash.

6. The fiber pellet of claim 4 wherein the inorganic material is clay.

7. The fiber pellet of claim 1 wherein the formed pellets comprise cellulose fibers in a range of about 60 to 99% by weight, plastics in a range of about 0 to 25% by weight, and inorganics in a range of about 0 to 40% by weight, wherein the pellets include at least about 1 to 5% by weight of either plastics or inorganics and not more than about 40% by weight of combined plastics and inorganics.

8. The fiber pellet of claim 1 wherein the fiber pellet is generally cylindrical in shape with diameter and length dimensions in a range of about 1/16 to 2 inches.

9. The fiber pellet of claim 1 wherein the fiber pellet is generally spherical in shape with a diameter dimension in a range of about 1/16 to 2 inches.

10. The fiber pellet of claim 1 wherein the fiber pellet is formed from raw material having a moisture content in a range of about 45 to 80 percent by weight.

11. The fiber pellet of claim 1 wherein the raw material comprises cellulose fiber mixed with plastics and/or inorganics.

12. The fiber pellet of claim 1 wherein the fiber pellet has a bulk density in a range of about 10 to 50 pounds per cubic feet.

13. A method of forming a cellulose fiber pellet comprising the steps of
drying a processed cellulose-based source material having a moisture content in a range of about 40 to 80 percent by weight to a moisture content in a range of about 0.1 to 14.0 percent by weight,
grinding the dried source material to reduce size of the source material, and
extruderlessly pelletizing the source material into a plurality of pellets.

14. The method of claim 13 wherein a binding material is indigenous to the source material.

15. The method of claim 14 wherein the binding material comprises plastic material.

16. The method of claim 14 wherein the binding material comprises inorganic material.

17. The method of claim 16 wherein the inorganic material is clay.

18. The method of claim 13 further comprising the step of sourcing the source material from waste streams of a paper mill process.

19. The method of claim 13 further comprising a step of compacting the source material to a bulk density in a range of about 10 to 50 pounds per cubic foot.

20. The method of claim 13 further comprising a second step of drying the source material between the grinding and pelletizing steps.
